(19) United States
(12) Patent Application Publication
(10) Pub. No.: US 2018/0163860 A1
(43) Pub. Date: Jun. 14, 2018

(54) TORQUE CONVERTER VALVE

(71) Applicant: Ford Global Technologies, LLC, Dearborn, MI (US)

(72) Inventor: Jichang RYU, West Bloomfield, MI (US)

(21) Appl. No.: 15/372,526

(22) Filed: Dec. 8, 2016

(51) Int. Cl. F16H 61/14; F16H 45/02

(52) U.S. Cl. CPC F16H 61/143; F16H 2061/145; F16H 2045/0221; F16H 45/02

(57) ABSTRACT

A torque converter is disclosed. The torque converter includes a cover, a turbine shroud disposed within the cover defining a charging chamber, and a torus chamber. The torque converter may also include at least one check valve disposed within the turbine shroud. The check valve may be configured to permit flow from the torus chamber to the charging chamber in response to a pressure difference between the torus chamber and the charging chamber. Permitting fluid flow from the torus chamber to the charging chamber may facilitate controlling the rate of lock-up-clutch slip.

### TECHNICAL FIELD

This disclosure relates to torque converter used in the automotive industry.

### BACKGROUND

Vehicles with an automatic transmission may utilize a torque converter that includes a bypass clutch that manages torque transfer between the impeller and the turbine of the torque converter. The torque converter is capable of engaging and disengaging the bypass clutch to transfer torque and to stop the transfer of torque across the torque converter. It is preferable to control the amount and speed of engagement and disengagement of the bypass clutch within the torque converter.

### SUMMARY

According to one embodiment of this disclosure, a torque converter is disclosed. The torque converter includes a cover, a turbine shroud disposed within the cover defining a charging chamber, and a torus chamber. The torque converter also includes a check valve disposed within the turbine shroud and is configured to permit flow from the torus chamber to the charging chamber in response to a pressure difference between the torus chamber and the charging chamber exceeding a threshold to facilitate controlling a rate of lock-up-clutch slip.

According to another embodiment of this disclosure, a torque converter is disclosed. The torque converter includes a cover that circumscribes an outer periphery of the torque converter, a turbine shroud defining a charging chamber and a torus chamber, an integrated turbine and an impeller disposed within the turbine shroud. A lock-up clutch is disposed between the turbine and the impeller and a pressure adjusting valve is disposed within the turbine shroud and the pressure adjusting valve facilitating a flow of fluid from the torus chamber to the charging chamber in response to a torus chamber pressure exceeding a threshold to facilitate controlling a rate of lock-up-clutch slip.

### BRIEF DESCRIPTION OF THE DRAWINGS

FIG. 1 is a cross sectional view of an example torque converter.

FIG. 2 is a detailed view taken along the circled area labeled 2.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Vehicles with an automatic transmission may utilize a torque converter that includes a clutch that manages torque transfer between the impeller and the turbine of the torque converter. The torque converter has a bypass clutch that facilitates torque transfer between the impeller and the turbine of the torque converter. The clutch may provide three modes of bypass clutch operation, and torque multiplication may occur depending on the amount of slip between the impeller and the turbine sides. In an unlocked mode or an open mode, a maximum amount of fluid is carried by the torque converter housing, separating the impeller from the turbine. In a locked mode, a minimum fluid pressure is carried in the torque converter so the pressure does not separate the impeller from the turbine and they become mechanically locked together. In a slip mode, a limited amount of slip is employed between the impeller and the turbine, whereby the fluid may provide the target ratio for torque multiplication, in addition to noise-vibration and harshness (NVH) damping.

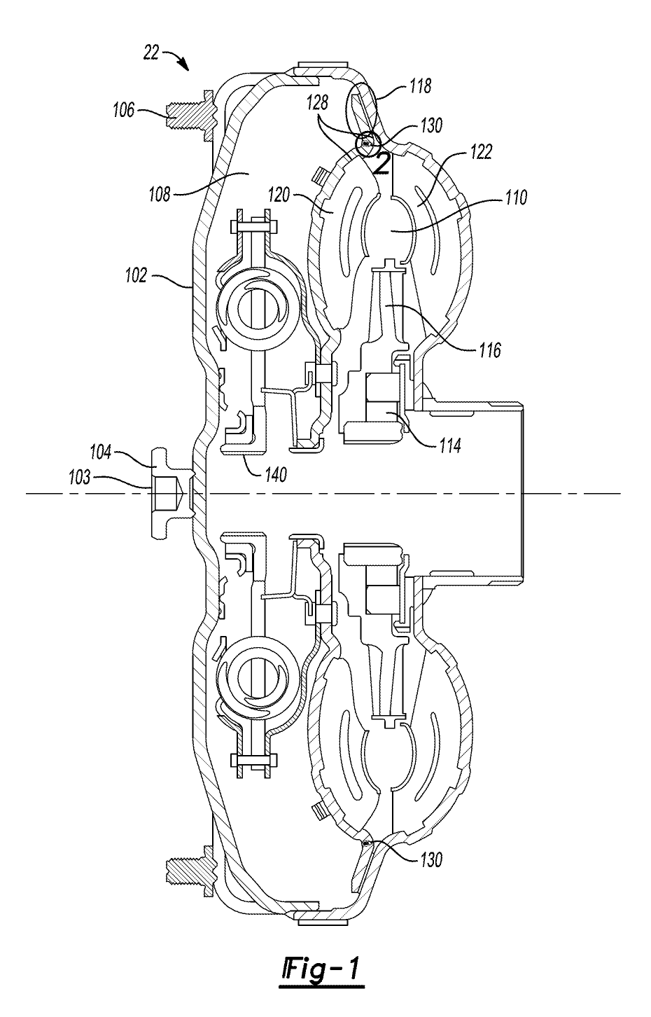

Referring to FIG. 1, a cross-sectional view of an example torque converter 22 is illustrated. The torque converter 22 transmits rotational power from the engine (not shown) to the transmission (not shown). The torque converter is connected to an engine (not shown) by bolting the stud 106 through a flywheel (not shown) as well as being piloted into the crank shaft (not shown) of an engine (now shown). The torque converter is connected with a spline engagement of the damper hub 140 to the input shaft (not shown) of a transmission (not shown). The stud 106 and pilot 104 are welded to the cover 102. The cover 102 is preferably welded to the impeller 122. A lock-up clutch, sometimes referred to as a clutch 118 includes friction material integrated within a portion of the turbine 120. The torque converter 22 includes two distinct sides; a charging chamber 108 and a torus chamber 110. The charging chamber is the portion of the torque converter 22 that extends above the pilot 104, to the stud 106, to the lock-up clutch 118. The torus chamber is defined by the turbine shroud and the impeller shroud. The torus chamber and the charging chamber may be referred to as “torus side” or “charging side,” respectively.

During operation, the cover 102 and impeller 122 rotate as the engine is running and the torque converter begins to fill with oil that is supplied from transmission. The impeller includes a number of blades that, in response to the torque generated by the engine, fluid is dispersed from the impeller 122 to a number of blades of the turbine 120. A reactor 116 includes a one-way clutch (OWC) 114 that is located between an inlet of the impeller 122 and an outlet of the turbine 120. The reactor 116 includes blades that re-direct transmission fluid received from an outlet of the turbine 120 and the inlet of the impeller 122. The re-direction of transmission fluid by the reactor 116 between the turbine and the impeller results in torque multiplication, providing a resultant torque from the impeller to the turbine. The resultant torque is transferred from the turbine through the damper hub 140, into the input shaft of the transmission (not shown). The clutch 118 may be referred to as a lock-up clutch for the purposes of this disclosure.

The clutch 118 is locked by increasing hydraulic pressure within the charging chamber 108 and a decrease in pressure within the torus chamber 110. In the locked state, a minimum amount of fluid flows through the clutch 118. The engine torque is directly transferred from exterior portion of the torque converter through turbine 120 via clutch 118 without torque multiplication obtained from reactor 116, damper hub 140 via multiple connections in the middle and finally into the input shaft of transmission (not shown). The clutch may go from its locked state into the slip mode by increasing the hydraulic pressure between the turbine and impeller so that the clutch 118 is separated. The amount of time required to go from the unlocked state to the locked state is known as the slip speed.

To increase fuel economy, it is advantageous to reduce the slip speed and the time required to go from the slipped mode to the locked mode. However, because the turbine and the impeller are rotating at two different speeds, locking them quickly at two different speeds may cause a driveline disturbance such as noise or vibration harshness (NVH). To allow for a gradual slip, it is advantageous to allow fluid flow from the torus chamber 110 to the charging chamber 108. As mentioned above, in the unlocked state, the fluid within the torus chamber is pressurized as compared to the fluid within the charging chamber. To facilitate a gradual reduction in pressure between the charging chamber 108 and the torus chamber 110 a pressure adjusting valve 130 is disposed within the turbine shroud 128.

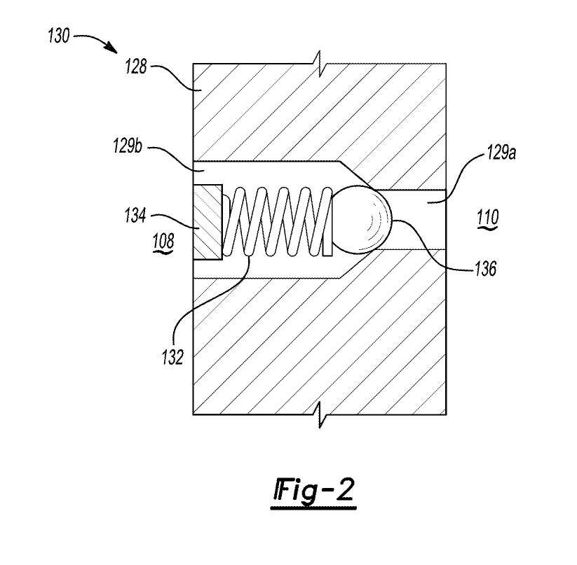

Referring to FIG. 2, a detailed view of the pressure adjusting valve 130 is illustrated. The turbine shroud 128 defines a channel that facilitates fluid flow from the torus chamber 110 and the charging chamber 110. The channel includes two portions, a torus chamber portion 129a and a charging chamber portion 129b. The charging chamber portion 129b has a wider cross-sectional area than the torus chamber portion 129a. A block 134 and a spherical check ball 136 are disposed within the channel. A spring 132 connects the block 134 and supports the spherical check ball 136. Because the spherical check ball 136 is larger than the torus chamber channel 129a, no fluid is permitted to flow from the torus side 110 to the charging chamber 108. The interior surface of the channel is more or less conically-tapered to guide the spherical check ball 136 into the seat and form a positive seal when stopping reverse flow.

As the fluid passes through the unlocked/open clutch 118 at an outermost portion of the torus chamber 110, the check ball 136 wedges into the torus channel 129a and blocks the flow of fluid from the torus chamber 110 to the charging chamber 108. The check ball 136 wedges into the torus chamber 129a because the spring 132 has sufficient strength to and the fluid pressure within the charging chamber 108 surpasses the fluid pressure within the torus chamber 110.

When transitioning from the unlocked to locked mode, the clutch 118 is closed in response to increased pressure within the charging chamber 108. As the clutch feature 118 is closed, the fluid within the torus chamber 110 is compressed and the pressure within the torus chamber 110 increases. Once the pressure within the torus chamber 110 surpasses the strength of the spring 132 combined with the pressure within the charging chamber 108 the ball 136 moves towards the charging chamber 108. When the ball 136 moves by compressing the spring 132, a controlled amount of fluid flow is permitted between the torus chamber 110, through the torus channel 129a, to the charging chamber channel 129b and eventually to the charging chamber 108. As the fluid passes through this channel, the pressure within the torus chamber 110 is gradually reduced so that the fluid passing through the clutch 118 at outermost portion of the torus chamber 110 flows at a decreased rate compared to when no fluid was permitted to flow through the valve 130.

The reduced flow through the clutch feature 118 decreases the pressure within the torus chamber 110 so that the clutch 118 is smoothly engaged without a loss in resistance. The gradual decrease in pressure provides to control the slip of the clutch 118. As the process is reversed, the pressure within the charging chamber 108 increases to a point where the spring 132 has sufficient force to move the check ball 136 to the torus channel 129a. The check ball 136 blocks the channel and does not permit fluid to flow from the torus chamber 110 to the charging chamber 108.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A torque converter comprising:
a cover;
a turbine shroud disposed within the cover to define a charging chamber and a torus chamber; and
a check valve disposed within the turbine shroud configured to permit flow from the torus chamber to the charging chamber in response to a pressure difference between the torus chamber and the charging chamber exceeding a threshold to facilitate controlling a rate of lock-up-clutch slip.

2. The torque converter of claim 1, wherein the pressure difference is defined by the torus chamber having a pressure greater than a pressure within the charging chamber.

3. The torque converter of claim 2, wherein the pressure difference results in a locking condition of the torque converter and wherein displacement of the valve facilitates a drop in pressure in a torus chamber pressure and results in a controlled slipping of the clutch.

4. The torque converter of claim 1, wherein controlling the rate of lock-up-clutch slip results in a decrease of vibration.

5. The torque converter of claim 1, wherein the valve has an open and closed position, wherein the check valve is opened, fluid flows from the torus chamber to the charging chamber and the pressure in the torus chamber is reduced.

6. The torque converter of claim 1, wherein the turbine shroud defines a channel having a charging chamber portion defining a cross-sectional area and a torus chamber portion defining a cross-section less than the charging chamber portion.

7. The torque converter of claim 6, wherein the check valve includes a block disposed within the charging chamber portion and a spherical check ball disposed in the torus chamber portion coupled by a spring, wherein the spring is compressed to facilitate a drop in a torus chamber pressure, in response to a pressure differential between the two chambers.

8. The torque converter of claim 6, wherein the charging chamber portion and the torus chamber portion are connected by an intermediate section defining a chamfer.

9. A torque converter comprising:
a cover circumscribing an outer periphery of the torque converter;
a turbine shroud defining a charging chamber and a torus chamber;
an integrated turbine and an impeller disposed within the torus chamber;
a lock-up clutch disposed between the turbine and the impeller; and
a pressure adjusting valve disposed within the turbine shroud wherein the pressure adjusting valve facilitates a flow of fluid from the torus chamber to the charging chamber in response to a torus chamber pressure exceeding a threshold to facilitate controlling a rate of lock-up-clutch slip.

10. The torque converter of claim 9, wherein controlling the rate of lock-up-clutch slip results in a decrease of vibration.

11. The torque converter of claim 9, wherein the pressure adjusting valve is movable from an open position and a closed position, wherein the pressure adjusting valve is opened, fluid flows from the torus chamber to the charging chamber and the pressure in the torus chamber is reduced.

12. The torque converter of claim 11, wherein the pressure adjusting valve in the open position facilitates a drop in pressure in the torus chamber and results in a controlled slipping of the clutch.

13. The torque converter of claim 9, wherein the turbine shroud defines a channel having a charging chamber portion defining a cross-sectional area and a torus chamber portion defining a cross-section less than the charging chamber portion.

14. The torque converter of claim 13, wherein there charging chamber portion and the torus chamber portion are connected by an intermediate section defining a chamfer.

15. The torque converter of claim 14, wherein the pressure adjusting valve includes a block disposed within the charging chamber portion, a spherical check ball disposed in the torus chamber portion coupled by a spring, wherein the spring is compressed to facilitate a drop in a torus chamber pressure, in response to a torus chamber pressure differential.

16. A torque converter comprising:
a cover;
a turbine shroud disposed within the cover to define a charging chamber and a torus chamber;
a first check valve disposed within the turbine shroud; and
a second check valve disposed circumferentially opposite of the first check valve within the turbine shroud, wherein each check valve is configured to permit flow from the torus chamber to the charging chamber in response to a pressure difference between the torus chamber and the charging chamber exceeding a threshold to facilitate controlling a rate of lock-up-clutch slip.
